(19) United States
(12) Patent Application Publication
(10) Pub. No.: US 2007/0019740 A1
(43) Pub. Date: Jan. 25, 2007

(54) VIDEO CODING FOR 3D RENDERING

(75) Inventor: Madhukar Budagavi, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/459,677

(22) Filed: Jul. 25, 2006

Related U.S. Application Data
(60) Provisional application No. 60/702,513, filed on Jul. 25, 2005.

(51) Int. Cl. H04N 11/02; H04N 7/12; H04N 11/04; H04B 1/66

(52) U.S. Cl. 375/240.25; 375/240.26

(57) ABSTRACT

Video coding to lower complexity of 3D graphics rendering of frames (such as textures on rectangles) includes scalable INTRA frame coding, such as by zero-tree wavelet transform; this allows decoding with mipmap level control from level of detail required in the rendering. Multiple video streams can be rendered as textures in a 3D environment.

### CROSS-REFERENCE TO RELATED APPLICATIONS

This application claims priority from provisional Appl. No. 60/702,513, filed Jul. 25, 2005. The following co-assigned copending patent application discloses related subject matter: Appl. No. ______, filed ______ (TI-38794).

### BACKGROUND OF THE INVENTION

The present invention relates to video coding, and more particularly to video coding adapted for computer graphics rendering.

There are multiple applications for digital video communication and storage, and multiple international standards have been and are continuing to be developed. H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation prediction plus transform coding of prediction residuals. Block motion compensation is used to remove temporal (inter coding) redundancy between successive images (frames), whereas transform coding is used to remove spatial (intra coding) redundancy within each frame. FIGS. 2a-2b illustrate H.264/AVC functions which include a deblocking filter within the motion compensation loop to limit artifacts created at block edges. An alternative to intra prediction is hierarchical coding, such as the wavelet transform option for intra coding in MPEG-4.

Interactive video games use computer graphics to generate images according to game application programs. FIG. 2c illustrates typical stages in computer graphics rendering which displays a two-dimensional image on a screen from an input application program that defines a virtual three-dimensional scene. In particular, the application program stage includes creation of scene objects in terms of primitives (e.g., small triangles that approximate the surface of a desired object together with attributes such as color and texture); the geometry stage includes manipulation of the mathematical descriptions of the primitives; and the rasterizing stage converts the three-dimensional description into a two-dimensional array of pixels for screen display.

FIG. 2d shows typical functions in the geometry stage of FIG. 2c. Model transforms position and orient models (e.g., sets of primitives such as a mesh of triangles) in model/object space to create a scene (of objects) in world space. A view transform selects a (virtual camera) viewing point and direction for the modeled scene. Model and view transforms typically are affine transformations of the mathematical descriptions of primitives (e.g., vertex coordinates and attributes) and convert world space to eye space. Lighting provides modifications of primitives to include light reflection from prescribed light sources. Projection (e.g., a perspective transform) maps from eye space to clip space for subsequent clipping to a canonical volume (normalized device coordinates). Screen mapping (viewport transform) scales to x-y coordinates for a display screen plus a z coordinate for depth (pseudo-distance) that determines which (portions of) objects are closest to the viewer and will be made visible on the screen. Rasterizing provides primitive polygon interior fill from vertex information; e.g., interpolation for pixel color, texture map, and so forth.

Programmable hardware can provide very rapid geometry stage and rasterizing stage processing; whereas, the application stage usually runs on a host general purposed processor. Geometry stage hardware may have the capacity to process multiple vertices in parallel and assemble primitives for output to the rasterizing stage; and the rasterizing stage hardware may have the capacity to process multiple primitive triangles in parallel. FIG. 2e illustrates a geometry stage with parallel vertex shaders and a rasterizing stage with parallel pixel shaders. Vertex shaders and pixel shaders are essentially small SIMD (single instruction multiple dispatch) processors running simple programs. Vertex shaders provide the transform and lighting for vertices, and pixel shaders provide texture mapping (color) for pixels. FIGS. 2f-2g illustrate pixel shader architecture.

Real-time rendering of compressed video clips in 3D environments creates a new set of constraints on both video coding methods and traditional 3D graphics architectures. Rendering of compressed video in 3D environments is becoming a commonly used element of modern computer games. In these games, video clips of real people are rendered in 3D game environments to create mood, setup game play, introduce characters, etc.

At the intersection of video coding and 3D graphics lie several other interesting non-game related applications. One example application that involves both video coding and 3D graphics is the idea of a 3D video vault in which video clips are being rendered on a wall of a room. The user could walk into the room and browse all the video clips in the room and decide on the one that he wants to watch. One could similarly think of other non-traditional ways of rendering traditional video clips. The Harry Potter movies show several ways of doing this. Note that in movies, non-real-time 3D graphics rendering is typically used. The proliferation of handheld devices that have video coding as well as 3D graphics hardware have made such applications practical and they can be expected to become more prevalent in the future.

Video is rendered in 3D graphics environments by using texture mapping. For example, in the scene shown in FIG. 6, render three rectangles (each rectangle is rendered as a set of two triangles) in 3D space and texture map three video frames (coming from three different video clips) onto these rectangles.

During the texture mapping process, a technique called mipmapping is widely used for texture anti-aliasing. Mipmapping is implemented on almost all modern graphics hardware cards. For creation of a mipmap, start with the original image (called level 0) as the base of the pyramid shown in FIG. 7. Additional levels of the pyramid (levels 1, 2, . . . ) are generated by creating a multiresolution decomposition of the base level as shown in FIG. 7. The whole pyramid structure is called a mipmap. Different levels of mipmaps are used based on the level of detail (LOD) of a triangle being rendered. For example, if the triangle is very near to the viewpoint, lower levels (higher resolutions) of the mipmaps are used; whereas, if the triangle is farther away from the viewpoint (hence it appears small on the screen), higher levels of the mipmaps are used.

However, these applications have complexity, memory bandwidth, and compression trade-offs in 3D rendering of video clips.

### SUMMARY OF THE INVENTION

The present invention provides video coding adapted to graphics rendering with decoding or frame mipmapping adapted to the level of detail requested by the rendering.

### BRIEF DESCRIPTION OF THE DRAWINGS

FIGS. 1a-1c illustrate a preferred embodiment codec and system.

FIGS. 2a-2g are functional block diagrams for video coding and computer garphics.

FIGS. 3a-3b show applications.

FIGS. 4a-4b illustrate a second preferred embodiment.

FIGS. 5a-5b illustrate a third preferred embodiment.

FIG. 6 shows three video clips in a 3D environment.

FIG. 7 is a heuristic mipmap organization.

FIGS. 8a-8b show video frame size dependence.

FIG. 9 shows clipping.

### DESCRIPTION OF THE PREFERRED EMBODIMENTS

### 1. Overview

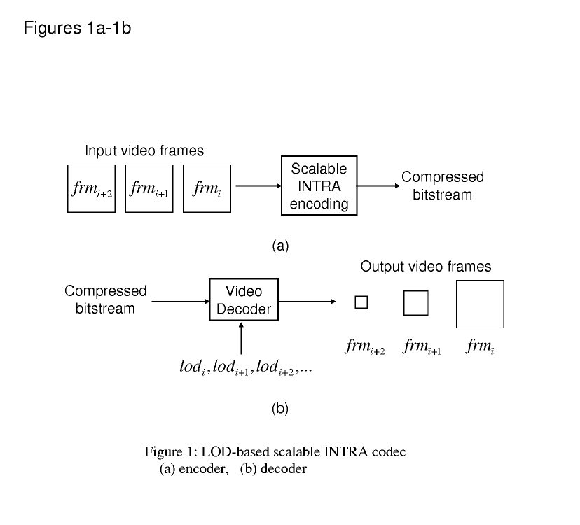

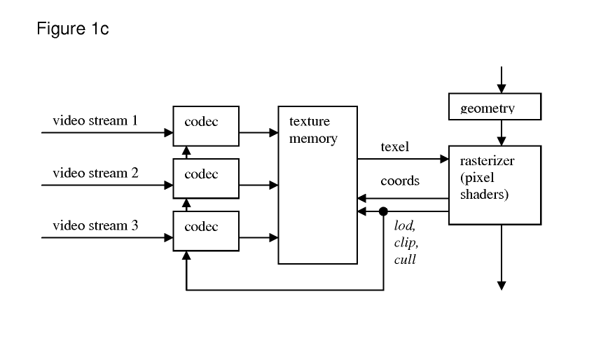

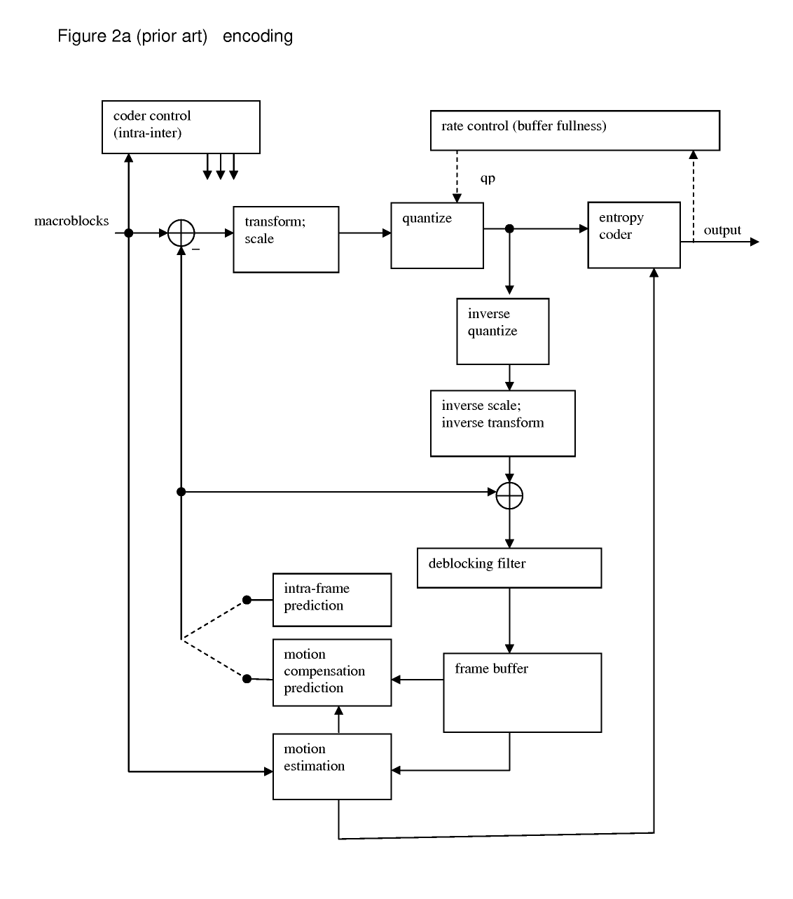

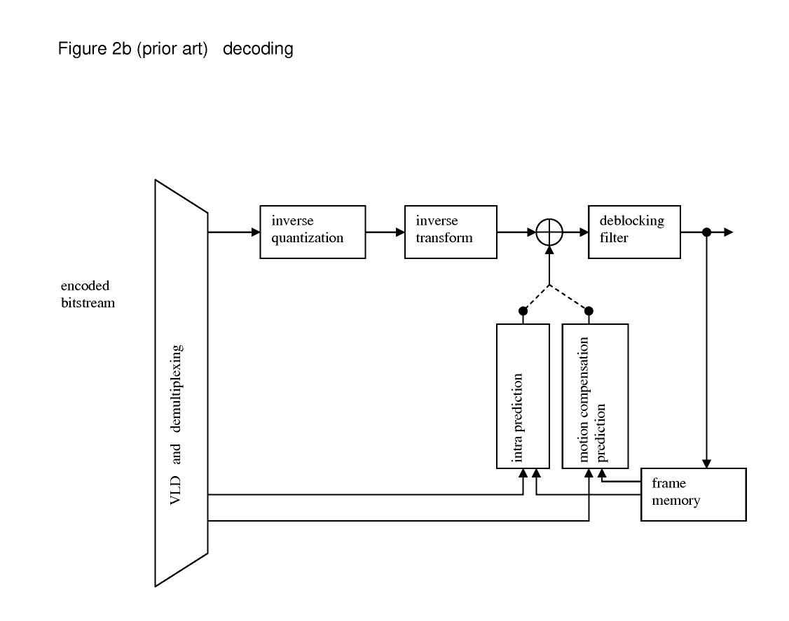

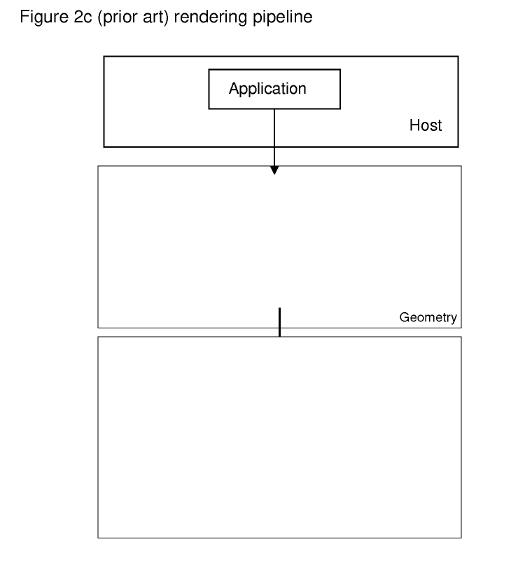

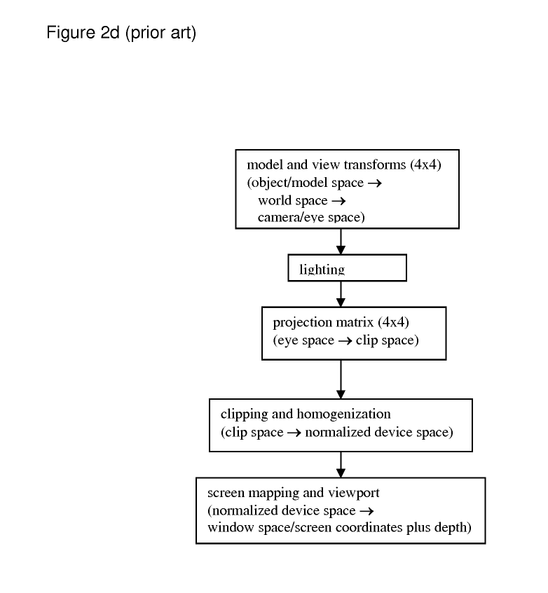

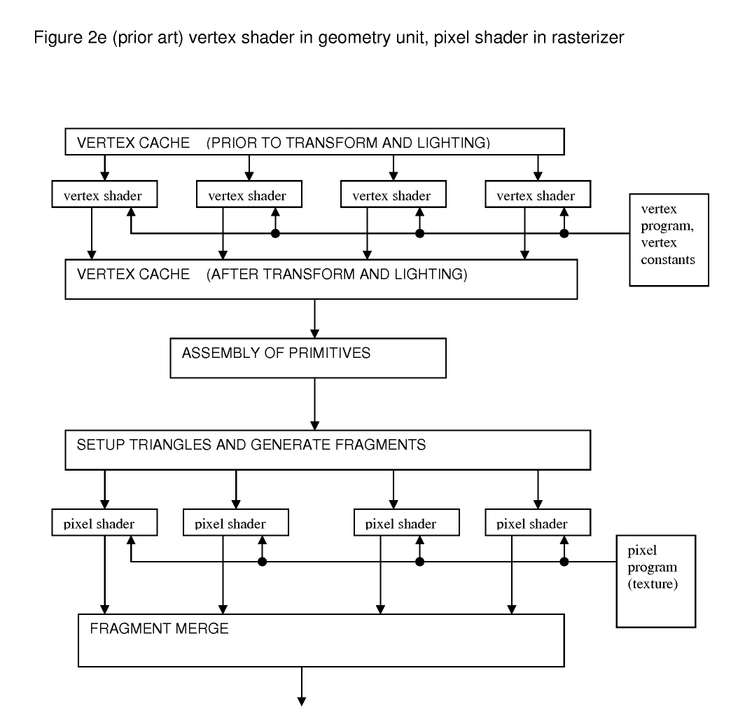

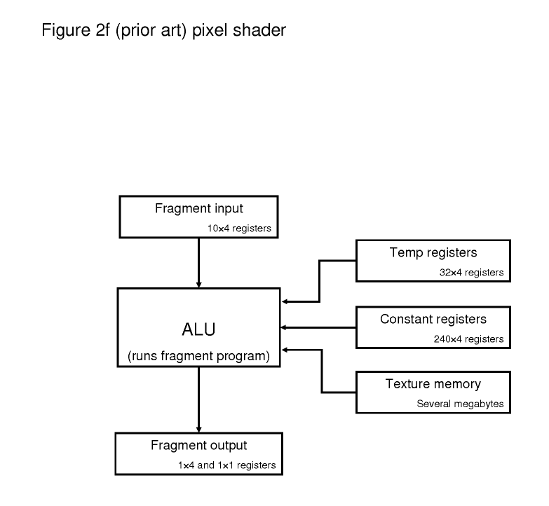

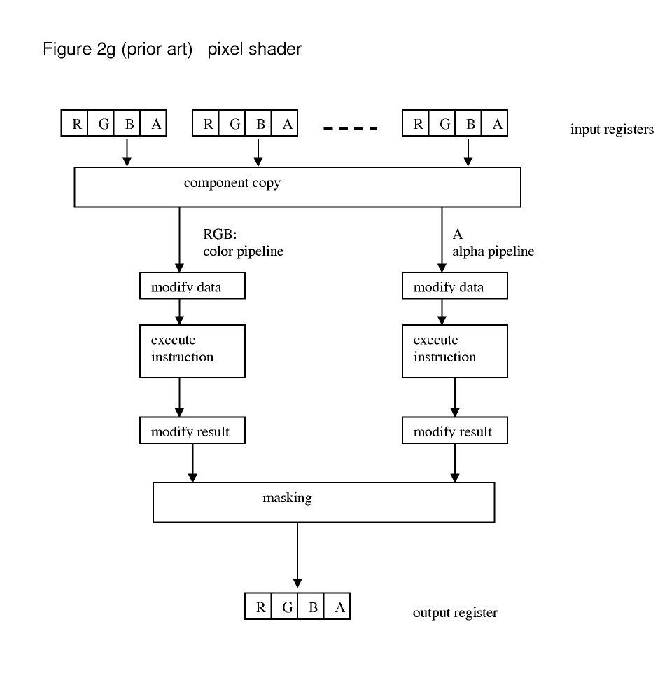

Preferred embodiment codecs and methods provide compressed video coding adapting to computer graphics processing requirements by the use of scalable INTRA frame coding and mipmap generation adaptive to the level of detail required. FIG. 1c illustrates an overall system with frames from up to three video streams rendered and using preferred embodiment codecs. FIGS. 1a-1b show a codec with scalable encoding together with decoding and frame mipmapping adapting to the level of detail requested by the rasterizer. Clipping and culling information can be used to further limit decoding to only frames (or portions thereof) required in the rendering.

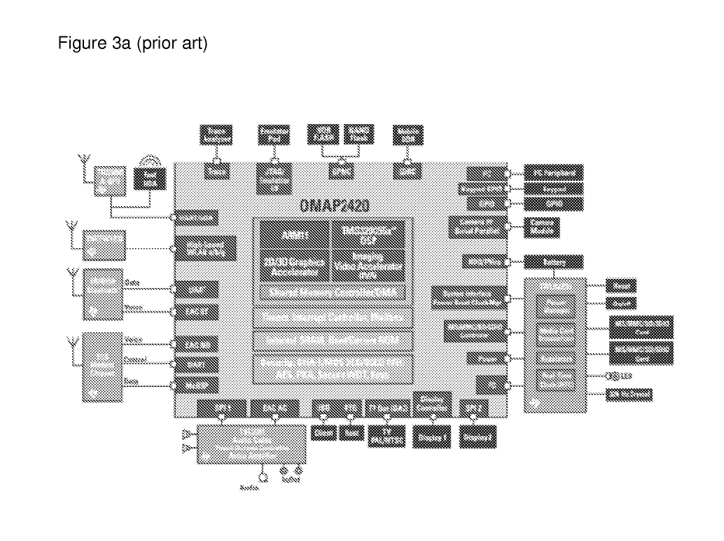

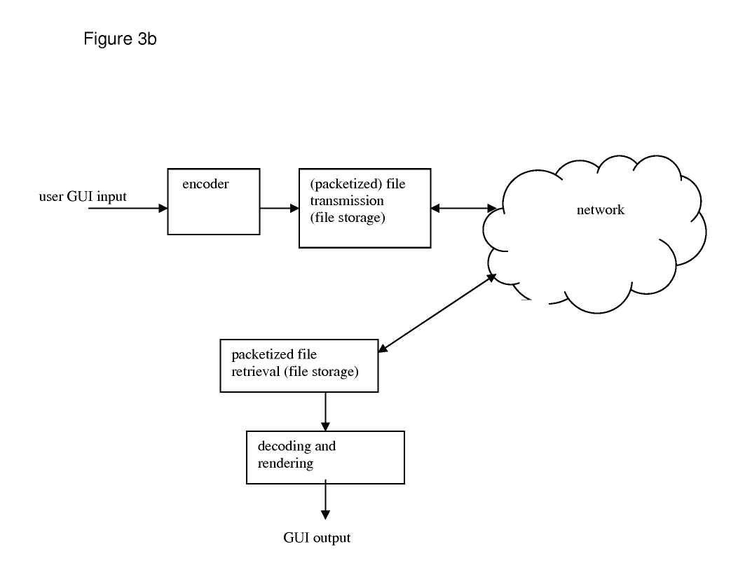

Preferred embodiment systems such as cellphones, PDAs, notebook computers, etc., perform preferred embodiment methods with any of several types of hardware: digital signal processors (DSPs), general purpose programmable processors, application specific circuits, or systems on a chip (SoC) such as combinations of a DSP and a RISC processor together with various specialized graphics accelerators (e.g., FIG. 3a). A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet as illustrated in FIG. 3b.

### 2. Preferred Embodiment Approach

The preferred embodiment methods of compressed video clip rendering in a 3D environment focus on lowering four complexity aspects: (a) mipmap creation, (b) level of detail (LOD), (c) video clipping, and (d) video culling. First consider these aspects:

(a) Mipmap Creation Complexity

Complexity in the creation of texture mipmaps is not typically considered in traditional 3D graphics engines. The mipmaps for a computer game are typically created either at the beginning of the game or are created off-line and loaded into the texture memory during game run time. Such an off-line approach is well suited for traditional textures. A texture image is typically used in several frames in a video game; e.g., textures of walls in a room get used as long as the user is in the room. Therefore there is a significant savings in complexity because of creation of the mipmaps a priori instead of creation while rendering a frame. However, for the case of video rendering in 3D environments, a priori creating of mipmaps provides no complexity reduction advantages because a video frame (at 30 fps) is typically used only once and discarded before the next 3D graphics frame. A priori mipmap creation also requires an enormous amount of memory to store all the uncompressed video frames and their mipmaps. Hence, a priori creation of mipmaps becomes infeasible and the mipmaps for all the video frames have to be generated at render time. This is a significant departure from traditional 3D graphics and has an impact on complexity and memory bandwidth. Table 1 shows the complexity and memory requirements for creation of mipmaps using a simple algorithm based on averaging of 2×2 area of a lower level to get a texel (defined as elements of texture images) in the upper level. Usage of more sophisticated spatial filters improves quality at the cost of increased computational complexity. In Table 1, the size of level 0 texture image is N×N.

TABLE 1
Computation complexity and memory bandwidth requirements
for simple mipmapping.

| Computational complexity | Memory bandwidth |
|---|---|
| ${N}^{2} + \frac{{N}^{2}}{4} + \frac{{N}^{2}}{16} + … + 1 = 1.33 {N}^{2}$ | ${N}^{2} + \frac{{N}^{2}}{4} + \frac{{N}^{2}}{16} + … + 1 = 1.33 {N}^{2}$ |

(b) Level of Detail (LOD)

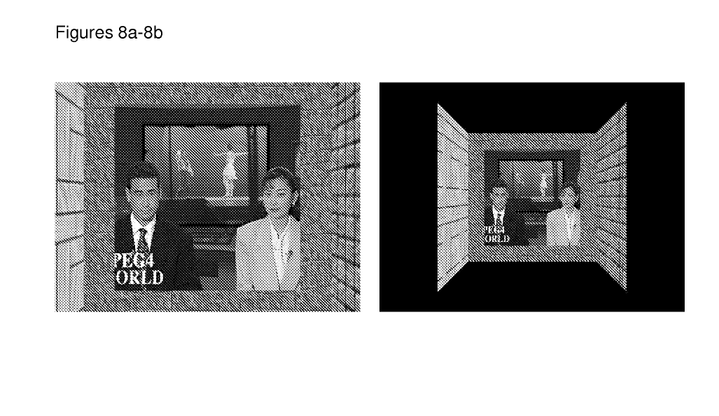

The size of a triangle rendered depends on how far the triangle is from the viewpoint. FIGS. 8a-8b illustrate this point; they show the same wall at different distances from the viewpoint. The level of detail (LOD) provides a rough estimate of the size of the triangle and used to select the matching level of mipmap for texture mapping. The texture mapping process will use lower levels (higher resolutions) of the mipmap when the triangle is nearer to the viewpoint and higher levels (lower resolutions) of the mipmap when the triangle is farther away from the viewpoint. Video coding methods that allow decoding only the resolutions that desired will lead to a saving of complexity and memory bandwidth.

(c) Video Clipping

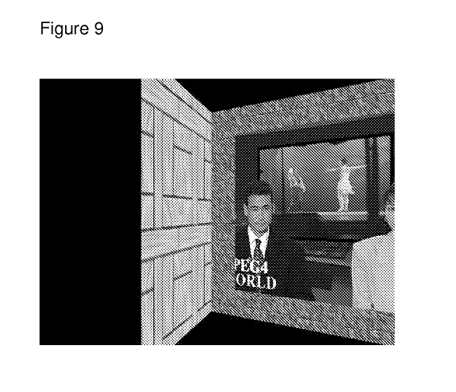

During a game, the player who is viewing the video might have to turn his head. This might be in response to an external stimulus such as an attack from an enemy combatant. The game player would have to turn his head to take care of the attacker. Another example where the user might have to turn his head is when there are multiple video clips on the walls of a room and the user turns from one to another. In these scenarios the video being displayed gets clipped. FIG. 9 shows an example of video clipping. Video coding methods that allow for decoding of only the unclipped regions will lead to computational complexity savings in the video decoding phase.

(d) Video Culling

Culling is a process in 3D graphics where entire portions of the world being rendered which will not finally appear on the screen are removed from the rendering pipeline. Culling leads to significant savings in computational complexity. Applying culling to video clips is a bit tricky. Examples of scenarios where video culling might arise are: A player who is watching a video clip containing a crucial clue in a game might have to completely turn away from the video clip to tackle an enemy combatant who is attacking from behind. If the player survives the attack, he might comeback and look at the video clue. Traditional video codecs use predictive coding between video frames to achieve improved compression. When predictive coding is used, even though the video is not visible to the player, the video decoder should continue the video decoding process to maintain consistency in time. However, decoding of culled video is a waste of computing resources since the video is not going to be seen on the screen. Video coding approaches that are friendly in terms of video culling need to be used in 3D graphics. Note that video culling leads to more significant savings than video clipping.

### 3. First Preferred Embodiments

FIGS. 1a-1b show the encoder and decoder block diagrams for a first preferred embodiment codec, and FIG. 1c shows functional blocks of a preferred embodiment system for three input video streams. In the encoder all the frames are INTRA coded using a multi-resolution scalable (hierarchical) codec such as those based on wavelets (e.g. EZW, SPIHT, JPEG2000). In the video decoder, for decoding frame formᵢ, the decoder makes use of the LOD information lodᵢ, and decodes only up to the resolution determined by lodᵢ. Therefore, when level 0 of the mipmap is not required for texture mapping, it is not generated. This is in contrast to the traditional approach where all the levels of the mipmap are generated independent of the actual LOD. By following a LOD-adaptable video decoding approach, the preferred embodiment methods save on both complexity and memory bandwidth. Note that with this approach, the mipmap pyramid is constructed from top to bottom and it gets constructed as a byproduct of the video decoding process.

Other advantages of LOD-based scalable INTRA coding include:

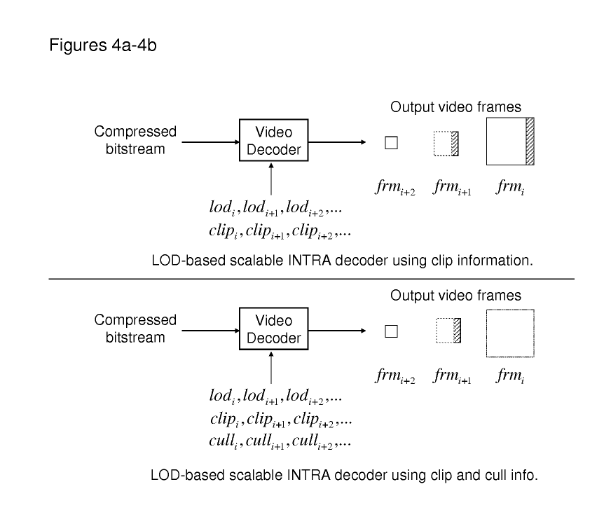

(i) Video clipping: Video clipping can be implemented easily in the LOD-based scalable INTRA decoder. The decoder only needs to reconstruct the portion of the video image visible in the current frame. Since predictive coding is not used, the invisible portions of the video frame do not get used in subsequent frames and can be safely not reconstructed. The decoder architecture of FIG. 1b can be extended to support this feature. FIG. 4a shows this extended architecture. The variable clipᵢ denotes the clip window to use for video frame formᵢ; clipᵢ comes from the 3D graphics context. Only the video frame that lies in the clip window is decoded. In the example shown in FIG. 4a, the shaded region of the output video frames are not decoded.

(ii) Video culling: Video culling can also be easily implemented by using the LOD-based scalable INTRA decoder. Since prediction is not used, the decoder need not decode the video frame when it is culled. The modified decoder architecture that allows culling of information is shown in FIG. 4b. The variable cullᵢ is a boolean flag that comes from the 3D graphics rendering context and indicates whether the current video frame is to be culled or not. In the example show in FIG. 4b, video frame formᵢ has been culled and hence it is not decoded at all.

### 4. Second Preferred Embodiments

A well know drawback of INTRA coding in video compression is that it requires mores bits than INTER coding. But it is hard to build an INTER codec that can efficiently make use of LOD, clip, and cull information.

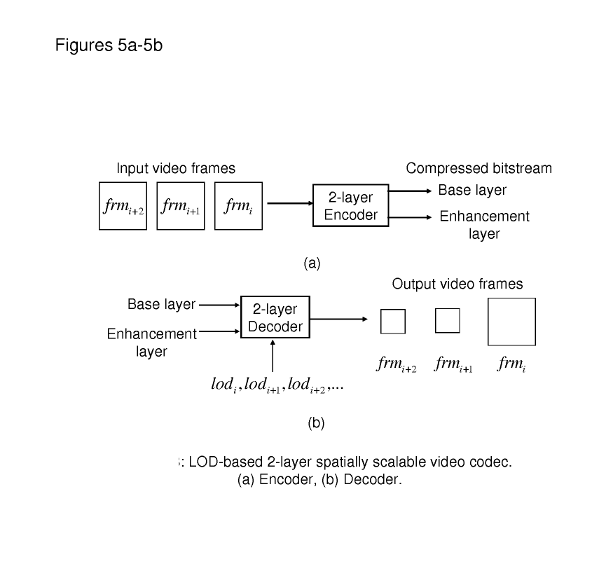

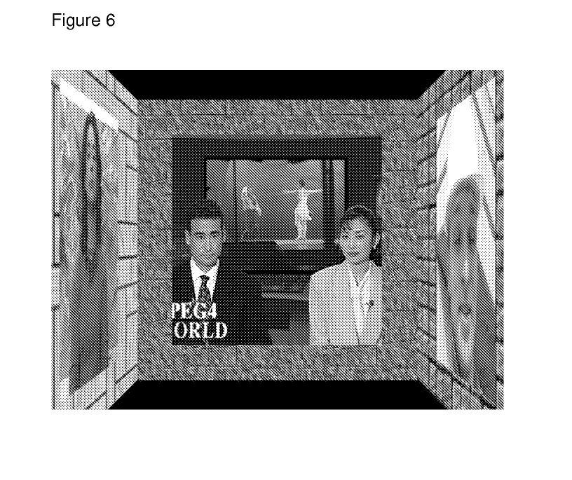

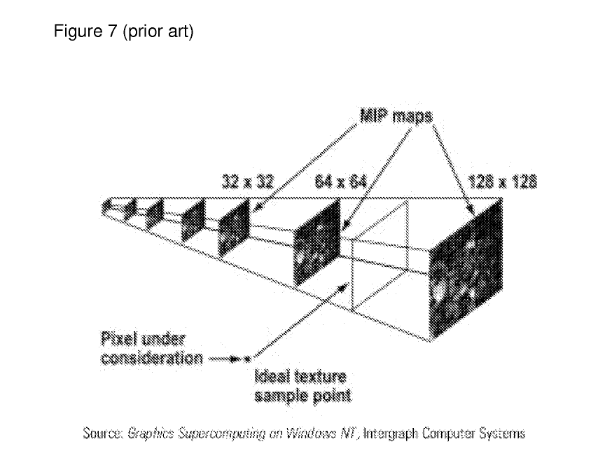

In the mipmap creation stage, most of the calculations and memory accesses occur when operating on level 0. For example, Table 1 shows that the total number of operations in the mipmap creation stage is 1.33 N². Out of this total, N² operations are used up when operating at level 0. So a 75% reduction in complexity and memory bandwidth can be achieved if level 0 of mipmap is not created when not required. Based on this observation, the second preferred embodiment uses a LOD-based 2-layer spatially scalable video coder. FIGS. 5a-5b show the codec block diagram.

The encoder generates two layers: the based layer and the enhancement layer. The base layer corresponds to video encoded at resolution N/2×N/2. Any standard video codec, such as MPEG-4, can be used to encode the base layer. The base layer encoding will use the traditional INTRA+INTER coding. To create the enhancement layer, first interpolate the N/2×N/2 base level video frame to size N×N. Then take the difference between the interpolated frame and the input video frame to get the prediction error. This prediction error is encoded in the enhancement layer. Note that MPEG-4 spatially scalable encoder supports implementation of such scalability.

The decoding algorithm is as follows:

Decode base layer
if(lodᵢ == 0)
{

decode enhancement layer and generate N × N

resolution video frame
}
Generate mipmaps at level 2, 3, ...

This method does not operate on level 0 if not required, and this provides most of the savings in the mipmap creation stage. It also provides most of the savings in the video culling stage as mentioned below.

(i) Video culling: The base layer cannot be culled because of INTER coding. However, the enhancement layer can be culled. This provides significant savings in computation when compared to the traditional video decoding scheme that decodes video at resolution N×N. Base layer video decoding complexity is equal to 0.25 times the traditional video decoding complexity. This is because the base layer is at resolution N/2×N/2 and the traditional video decoding is at resolution N×N.

(ii) Video clipping: Video clipping cannot be done at the base layer since INTER coding is used. Clipped portion of the video frame can get used in decoding of subsequent video frames. However, video clipping can be done at the enhancement layer.

### 5. Modifications

The preferred embodiments may be modified in various ways while retaining one or more of the features of video coding for rendering with decoding and mipmapping dependent upon level of detail or clipping and culling.

For example, the base layer plus enhancement layer for inter coding could be extended to a base layer, a first enhancement layer, plus a second enhancement layer so the base layer would be an interpolation of N/4×N/4. And the methods extend to coding interlaced fields instead of frames; that is, to pictures generally.

What is claimed is:

1. A method of video decoding, comprising the steps of:
(a) receiving encoded video, said encoded video with I-pictures encoded with a scalable coding;
(b) decoding a first of said encoded I-pictures according to a level of detail for said first I-picture; and
(c) forming a mipmap for said first I-picture according to said first level of detail.

2. The method of claim 1, wherein said decoding of said first I-picture is limited to a portion less than all of said first I-picture according to a clipping signal.

3. A video decoder, comprising:
(a) an I-picture decoder with input for receiving scalably-encoded I-pictures; and
(b) a rasterizer coupled to said I-picture decoder.

4. The decoder of claim 3, wherein said decoder is operable to limit decoding of an I-picture to a portion less than all of said I-picture according to a culling signal.
